(19) United States
(12) Patent Application Publication
(10) Pub. No.: US 2011/0171463 A1
(43) Pub. Date: Jul. 14, 2011

(54) Vanadium-based hard material coating of a wind power plant component

(76) Inventors: Andreas Christian Hohle, Alsdorf (DE); Christian Hohmann, Mulheim an der Ruhr (DE); Claudia Kummer, Aachen (DE); Helmut Kölpin, Baesweiler (DE); Ying Li, Aachen (DE); Brice Tchemtchoua, Aachen (DE)

(21) Appl. No.: 12/987,185

(22) Filed: Jan. 10, 2011

(30) Foreign Application Priority Data
Jan. 14, 2010 (DE) 10 2010 004 661.2

(51) Int. Cl. B32B 15/04; C23C 4/10

(52) U.S. Cl. 428/336; 427/453; 428/457; 428/472; 428/334; 428/335

(57) ABSTRACT

A wind power plant is provided including at least one component with a surface. The surface is coated at least partially with a hard material layer, preferably a vanadium-based hard material layer. Further, a wind park and a method of improving a characteristic of a surface of a component of a wind power plant are provided.

### CROSS REFERENCE TO RELATED APPLICATIONS

This application claims priority of German Patent Application No. 10 2010 004 661.2 DE filed Jan. 14, 2010, which is incorporated by reference herein in its entirety.

### FIELD OF INVENTION

The present invention relates to a wind power plant, a wind park and a method for improving a characteristic of a surface of a component of a wind power plant.

### SUMMARY OF INVENTION

In order to guarantee the expected service life of wind power plants, it is imperative to reduce the wear of the mechanical components installed therein. At the same time, with a focus on efficiency, it is imperative to improve the degree of efficiency of the plants.

Thermal hardening processes and modified lubricants have to date been used in wind power plants in order to minimize the wear, in particular of the mechanical components, or in order to improve the degree of efficiency.

It is a first object of the present invention to provide an advantageous wind power plant. A second object of the present invention consists in providing an advantageous wind park. Furthermore, a third object of the invention consists in providing an advantageous method for improving a characteristic of a surface of a component of a wind power plant.

The first object is achieved by a wind power plant; the second object is achieved by a wind park and the third object is achieved by a method for improving a characteristic of a surface of a component of a wind power plant according to the independent claims. The dependent claims contain further, advantageous embodiments of the invention.

The inventive wind power plant includes at least one component with a surface. The surface is coated at least partially with a hard material layer. The component may be in particular a mechanical component. Hard material layers at the same time offer a high potential both in order to minimize wear and also in order to increase the degree of efficiency of parts which are moved relative to one another. In conjunction with the present invention, a mechanical component can be understood to mean in particular a component which has a mechanical function or is subjected to mechanical stress.

Advantageously, the surface can be coated at least partially with a vanadium-based hard material layer. In addition to the general advantages of hard material layers, vanadium-based hard material layers have self-lubricating characteristics. The self-lubricating characteristics materialize as a result of the formation of Magneli phases, in particular of vanadium oxides. As a result of the self-lubricating characteristics of the vanadium-based hard material layer, the emergency operation of the respective component is significantly improved. Furthermore, the failure behavior of the respective component is also improved.

The vanadium-based hard material layer can include in particular vanadium aluminum nitrite (VAIN) and/or vanadium oxide. As already mentioned previously, the coating has self-lubricating characteristics by virtue of the formation of Magneli phases of the vanadium oxide.

Furthermore, the surface of the component may include steel or consist of steel. The surface of the steel can be coated at least partially with a hard material layer, preferably with a vanadium-based hard material layer. The steel may be a hardened or unhardened steel.

The component of the wind power plant may be for instance a tower, a pod, a rotor, a rotor hub, a rotor blade, a drive, an element of a drive, a brake, an axis of rotation or an element of a generator, in particular a mechanical element of a generator.

The hard material layer may have a layer thickness between 10 nm and 100 μm, advantageously between 10 nm and 10 μm. The surface of the inventive component may only be coated partially, but also completely with a hard material.

The hard material coating, in particular the vanadium-based hard material coating, can essentially also function as a corrosion protection for the respective component.

The inventive wind park includes at least one inventive wind power plant. The wind park has the same characteristics and advantages as the previously described inventive wind power plant. In this respect, reference is made to the observations made in connection with the inventive wind power plant.

The inventive method for improving a characteristic of a component of a wind power plant is characterized in that the surface of the component is coated at least partially with a hard material. The component may preferably be a mechanical component. Advantageously, the surface can be coated at least partially with a vanadium-based hard material. Reference is made to the observations made above in connection with the inventive component in respect of the advantages of the hard material layers and in particular vanadium-based hard material layers. The surface can preferably be coated with vanadium aluminum nitrite and/or vanadium oxide.

With the aid of the inventive method, the degree of efficiency and/or the resistance to wear, in particular of abutting surfaces or bearing surfaces, can be increased for instance. In addition to minimizing wear and increasing the degree of efficiency, the achieved coating can also be used as a corrosion protection.

Within the scope of the inventive method, the surface of the component can only be partially, or also completely coated with a hard material. The surface can be coated for instance by means of physical vapor deposition (PVD). In addition, the surface may include steel. The steel may be a hardened or unhardened steel. The hard material may be applied at least partially to the steel.

The surface can preferably be coated at least partially with a hard material, in particular a vanadium-based hard material, with a layer thickness between 10 nm and 100 μm, advantageously between 10 nm and 10 μm.

### BRIEF DESCRIPTION OF THE DRAWINGS

Further features, characteristics and advantages of the present invention are described in more detail below on the basis of an exemplary embodiment with reference to the appended Figures.

FIG. 1 shows a schematic representation of a wind power plant.

FIG. 2 shows a schematic representation of a section through part of a component of a wind power plant.

### DETAILED DESCRIPTION OF INVENTION

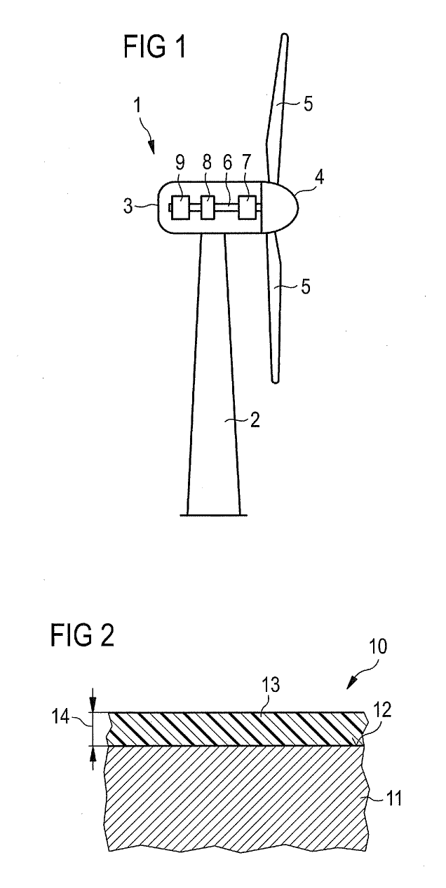

An exemplary embodiment of the invention is described in more detail below with aid of FIGS. 1 and 2. FIG. 1 shows a schematic representation of a wind power plant 1. The wind power plant 1 includes a tower 2, a pod 3 and a rotor hub 4. The pod 3 is arranged on the tower 2. The rotatably mounted rotor hub 4 is arranged on the pod 3. At least one rotor blade 5 is fastened to the rotor hub 4.

The wind power plant 1 also includes at least one axis of rotation 6, a drive 7, a brake 8 and a generator 9. The axis of rotation 6, the drive 7, the brake 8 and the generator 9 are arranged inside the pod 3. An axis-center difference is essentially possible in the drive 7. Different components can therefore have different axes of rotation.

FIG. 2 shows a schematic representation of a section through a part of a mechanical component 10 of the wind power plant 1. The mechanical component 10 may be for instance the tower 2, the pod 3, the rotor hub 4, the rotor blade 5, the drive 7, the blade 8, the axis of rotation 6 or the generator 9. The mechanical component 10 may likewise be an element of the afore-cited component.

In the present exemplary embodiment, the mechanical component 10 includes hardened or unhardened steel 11. The steel 11 includes a surface 12, which is coated with a hard material layer 13. The hard material layer is preferably a vanadium-based hard material layer.

The hard material layer may be applied to the surface 12 of the steel 11 with the aid of physical vapor deposition for instance. The hard material layer 13 has a layer thickness 14 between 10 nm and 100 μm. The hard material layer is preferably a maximum of a few μm thick.

1.-14. (canceled)

15. A wind power plant, comprising:
a component with a surface, wherein the surface is coated at least partially with a hard material layer.

16. The wind power plant as claimed in claim 15, wherein the surface is coated at least partially with a vanadium-based hard material layer.

17. The wind power plant as claimed in claim 16, wherein the vanadium-based hard material layer includes vanadium aluminum nitrite.

18. The wind power plant as claimed in claim 16, wherein the vanadium-based hard material layer includes vanadium oxide.

19. The wind power plant as claimed in claim 17, wherein the vanadium-based hard material layer includes vanadium oxide.

20. The wind power plant as claimed in claim 15, wherein the surface of the component includes steel, the surface of the steel being coated at least partially with the hard material layer.

21. The wind power plant as claimed in claim 15, wherein the component is a tower, a pod, a rotor, a rotor hub, a rotor blade, a drive, an element of a drive, a brake, an axis of rotation or an element of a generator.

22. The wind power plant as claimed in claim 15, wherein the hard material layer comprises a layer thickness between 10 nm and 100 μm.

23. The wind power plant as claimed in claim 22, wherein the hard material layer has a layer thickness between 10 nm and 10 μm.

24. A wind park, comprising:
at least one wind power plant, the wind power plant comprising:
a component with a surface, wherein the surface is coated at least partially with a vanadium-based hard material layer.

25. The wind park as claimed in claim 24, wherein the vanadium-based hard material layer includes vanadium aluminum nitrite.

26. The wind park as claimed in claim 24, wherein the vanadium-based hard material layer includes vanadium oxide.

27. A method for improving a characteristic of a surface of a component of a wind power plant, comprising:
providing a component of a wind power plant; and
coating a surface of the component at least partially with a hard material.

28. The method as claimed in claim 27, wherein the surface is coated at least partially with a vanadium-based hard material.

29. The method as claimed in claim 27, wherein the surface is coated with vanadium aluminum nitrite.

30. The method as claimed in claim 27, wherein the surface is coated with vanadium oxide.

31. The method as claimed in claim 29, wherein the surface is coated with vanadium oxide.

32. The method as claimed in claim 27, wherein the surface is coated by physical vapor deposition.

33. The method as claimed in claim 27, wherein the surface includes steel and the hard material is applied at least partially to the steel.

34. The method as claimed in claim 27, wherein the surface is coated at least partially with the hard material having a layer thickness between 10 nm and 100 μm.
